(19) United States
(12) Patent Application Publication
(10) Pub. No.: US 2011/0088994 A1
(43) Pub. Date: Apr. 21, 2011

(54) VERTICAL CHAIN-DRIVEN CONVEYOR APPARATUS FOR A MERCHANDISE DISPLAYING DEVICE

(76) Inventor: Tieh-Han WU, Tainan City (TW)

(21) Appl. No.: 12/581,387

(22) Filed: Oct. 19, 2009

(51) Int. Cl. B65G 17/12; B65G 41/00; B65G 17/14; A47F 3/08; A47B 81/00

(52) U.S. Cl. 198/300; 198/793; 198/803.12

(57) ABSTRACT

A vertical chain-driven conveyor apparatus includes two upright side frames, two sets of upper and lower sprockets mounted revolvably and respectively on the side frames, and a pair of endless chains, each trained on a respective set of the upper and lower sprockets for elevating and lowering a plurality of merchandise rolls. Each chain is guided by a guide rail unit to smoothly travel along an upright running route. A pair of chain-tension adjusting units are respectively coupled with the upper sprockets such that the upper sprockets can be moved upwardly relative to the lower sprockets to properly tense the chains.

### BACKGROUND OF THE INVENTION

1. Field of the Invention

This invention relates to a merchandise displaying device, more particularly to a vertical chain-driven conveyor apparatus for a merchandise displaying device, which is capable of elevating and lowering merchandise rolls on display.

2. Description of the Related Art

Referring to FIGS. 1 and 2, a conventional merchandise displaying device 1 for suspending a plurality of horizontally extending merchandise rolls 10 (only one is shown), such as rolls of fabric, sunshade tin films, etc., includes an upright support frame 11, a drive unit 12 mounted on the support frame 11, two chain-driven mechanisms 13 spaced apart from each other and driven by the drive mechanism 12, and a plurality of support units 14 mounted on the chain-driven mechanisms 13 to support the merchandise rolls 10.

The support frame 11 includes two side frames 111 spaced apart from each other. The drive unit 12 includes an upper shaft 121 disposed between upper portions 114 of the side frames 111, a lower shaft 122 disposed between lower portions 112 of the side frames 111, and a motor 123 disposed to drive the lower shaft 122. Each of the chain-driven mechanisms 13 includes upper and lower sprockets 132,131 respectively and rotatably mounted on the upper and lower shafts 121,122, a middle auxiliary sprocket 133, and an endless chain 134 trained on the sprockets 131,132,133. Each of the support units 14 includes two fixtures 141 mounted on the chain 134, and an axle 142 interconnecting the fixtures 141 for rollably supporting a merchandise roll 10. By means of the drive mechanism 12, the chain 134 can be moved along a loop so as to elevate and lower the merchandise rolls 10 for displaying and storing purposes.

However, since such merchandise rolls 10 are bulky and weighty, the chain 134 is liable to become loose after long-term use, thus resulting in unsmooth operation of the chain 134 and slippage of the chain 134 from the sprockets 131,132,133.

### SUMMARY OF THE INVENTION

The object of the present invention is to provide a vertical chain-driven conveyor apparatus which has chain-tension adjusting means to keep an endless chain in proper mesh with upper and lower sprockets.

According to this invention, the vertical chain-driven conveyor apparatus includes a pair of upright side frames, two sets of upper and lower sprockets, a pair of endless chains, a pair of guide rail units, and a pair of chain-tension adjusting units. The side frames are spaced apart from each other in a longitudinal direction. Each set of the upper and lower sprockets is mounted on the respective side frame to be revolvable about a sprocket axis extending in the longitudinal direction. Each chain is trained on a corresponding set of the upper and lower sprockets, and includes front and rear straight segments which are movable respectively along front and rear running routes that extend in an upright direction and between the corresponding set of the upper and lower sprockets, and that are spaced apart from each other in a transverse direction relative to the upright and longitudinal directions. Each guide rail unit is mounted on the respective side frame, extends in the upright direction, and defines front and rear guideways which respectively guide the front and rear straight segments of the respective chain to move along the front and rear running routes, respectively. Each chain-tension adjusting unit is coupled with the respective upper sprocket, and is movable relative to the respective side frame in the upright direction between a tensed position, where each chain is meshed with the corresponding set of the upper and lower sprockets, and a slack position, where each chain is loosely engaged with the corresponding set of the upper and lower sprockets.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic front view of a conventional merchandise displaying device;

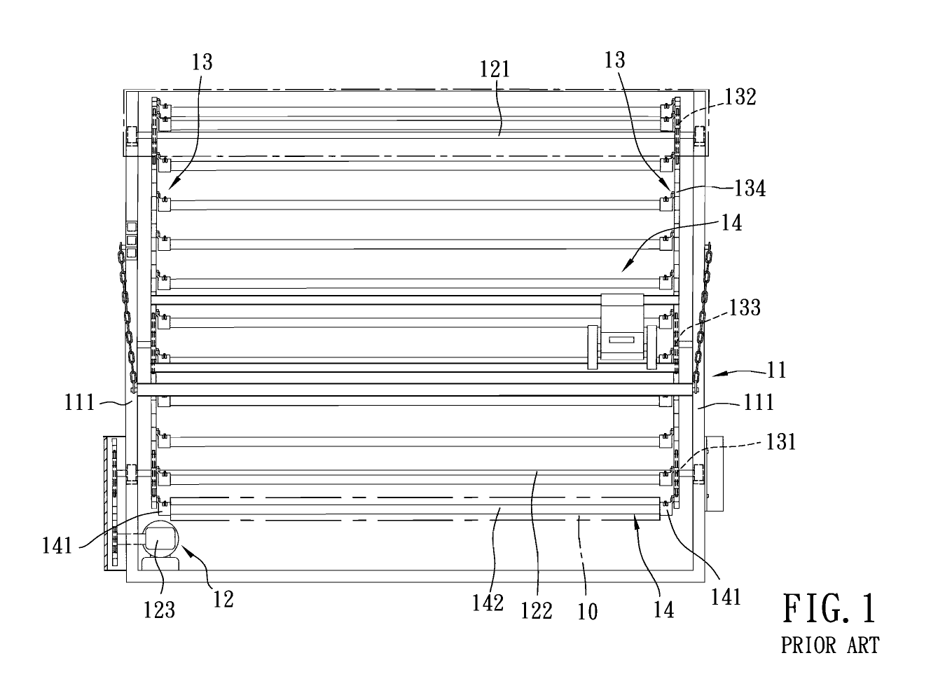

FIG. 2 is a schematic side view of the conventional merchandise displaying device;

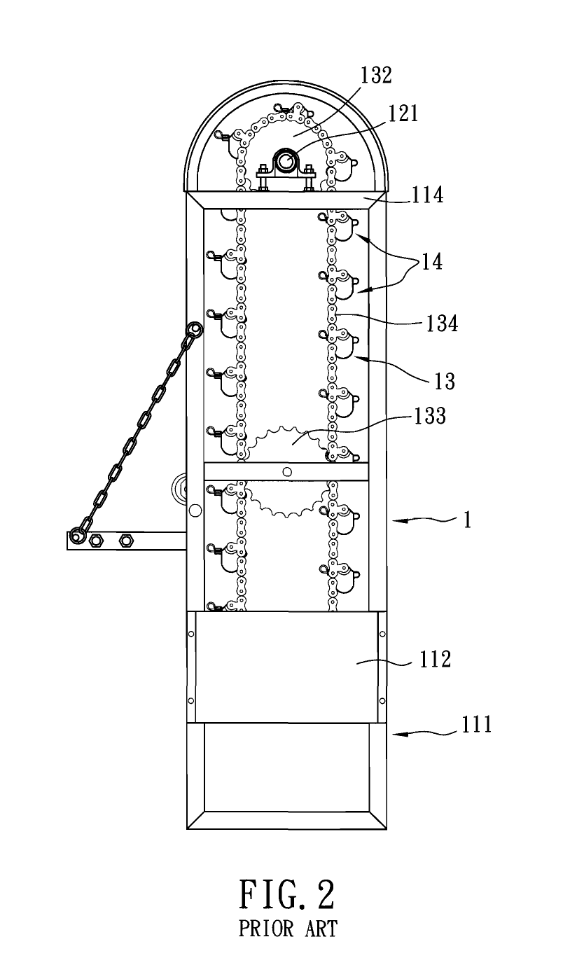

FIG. 3 is a perspective view of the preferred embodiment of a vertical chain-driven conveyor apparatus for a merchandise displaying device according to this invention;

FIG. 4 is a schematic front view of the preferred embodiment;

FIG. 5 is a schematic side view of the preferred embodiment;

FIG. 6 is a sectional view taken along lines 6-6 of FIG. 5;

FIG. 7 is a fragmentary exploded perspective view of a portion of the preferred embodiment; and

FIG. 8 is a fragmentary side view of a portion of the preferred embodiment.

### DETAILED DESCRIPTION OF THE PREFERRED EMBODIMENT

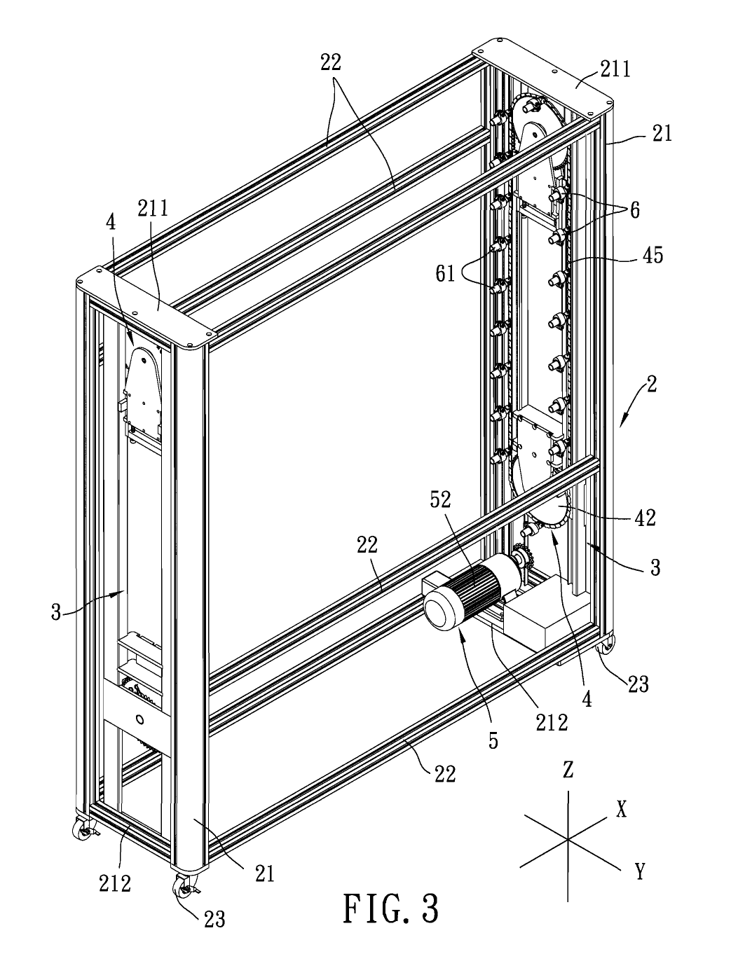

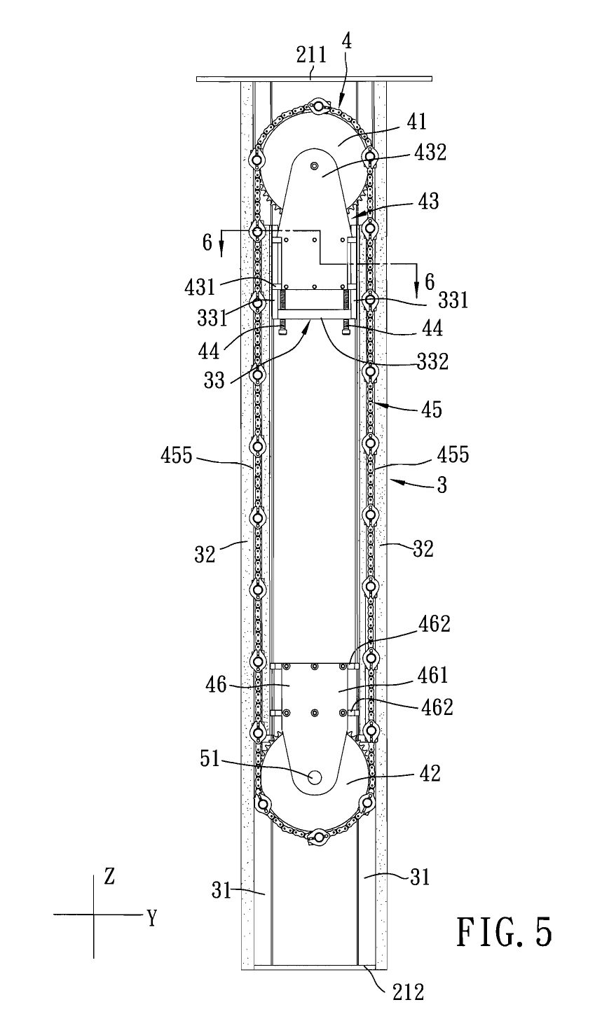

Referring to FIGS. 3 to 5, the preferred embodiment of a vertical chain-driven conveyor apparatus for a merchandise displaying device according to the present invention is shown to comprise a support frame 2, a pair of guide rail units 3, a pair of guiding rack units 33, a pair of chain-tension adjusting units, a pair of chain-driven mechanisms 4, a drive unit 5, and a plurality of supporting units 6.

The support frame 2 includes a pair of side frames 21 which are spaced apart from each other in a longitudinal direction (X), and each of which has top and bottom ends 211,212 opposite to each other in an upright direction (Z) that is transverse to the longitudinal direction (X), a plurality of crossbars 22 interconnecting the side frames 21, and a plurality of casters 23 disposed on the bottom ends 212 of the side frames 21 for easy movement of the apparatus.

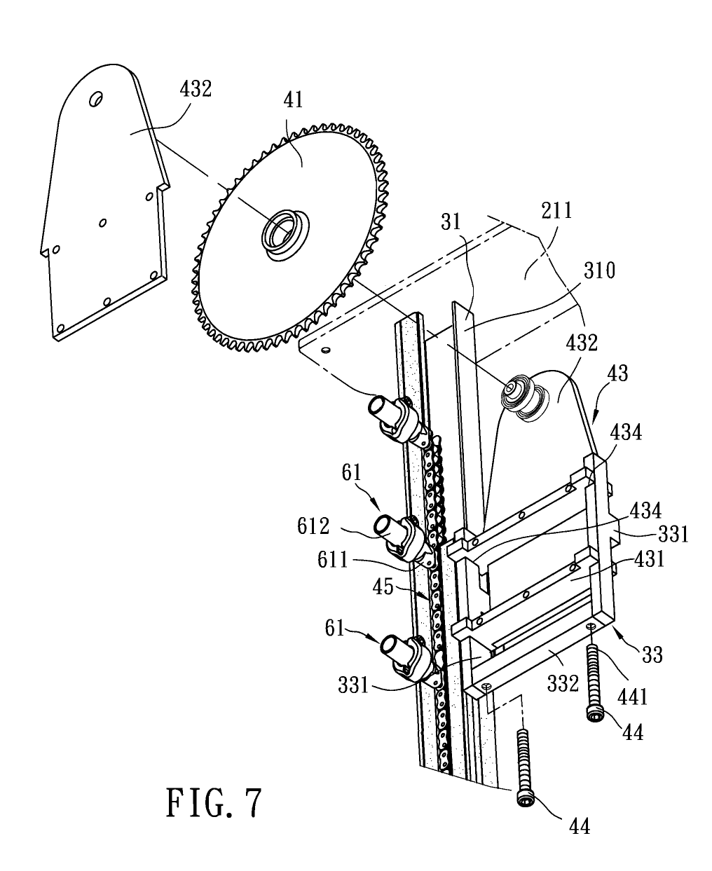

Referring to FIGS. 3, and 5 to 7, the guide rail units 3 are respectively mounted on the side frames 21. Each of the guide rail units 3 includes front and rear rails 31 and front and rear pads 32. The front and rear rails 31 extend in the upright direction (Z) and are spaced apart from each other in a transverse direction (Y) relative to the longitudinal and upright directions (X, Z). Each of the front and rear rails 31 has two angle bars 310,311 which are spaced apart from each other in the transverse direction (Y), a connecting wall 312 interconnecting the angle bars 310,311 to cooperatively define an elongated passage 314 with the angle bars 310,311, and two bent segments 313 which extend toward each other and which are spaced apart from each other by an accommodating gap 315 which extends in the upright direction (Z). Each of the front and rear pads 32 has two pad portions 321 which extend in the upright direction to upholster the bent segments 313, respectively, which are configured to cooperatively define front and rear guideways 322 extending along front and rear running routes, respectively, and which are made from a material that can muffle noisy sound.

Each of the guiding rack units 33 includes a pair of guide bars 331 which are secured to a respective one of the side frames 21 and between the angle bars 310 of the front and rear rails 31 of a respective one of the guide rail units 3, which are disposed parallel to each other, and which are spaced apart from each other in the transverse direction (Y), and a crosspiece 332 disposed between the guide bars 331.

Each of the chain-tension adjusting units includes an upper mount 43 and a pair of tightening bolts 44. The upper mount 43 has two guided portions 434 which are in the form of sliding grooves 434 and which are engaged with and guided by the guide bars 331 to move in the upright direction (Z), and an abutted portion 431 which is interposed between the guided portions 434 and which confronts the crosspiece 332 in the upright direction (Z). The tightening bolts 44 are in the form of threaded bolts 44 to be threadedly engaged with the crosspiece 332, and have actuating ends 441 which extend upwardly of the crosspiece 332 to abut against the abutted portion 431.

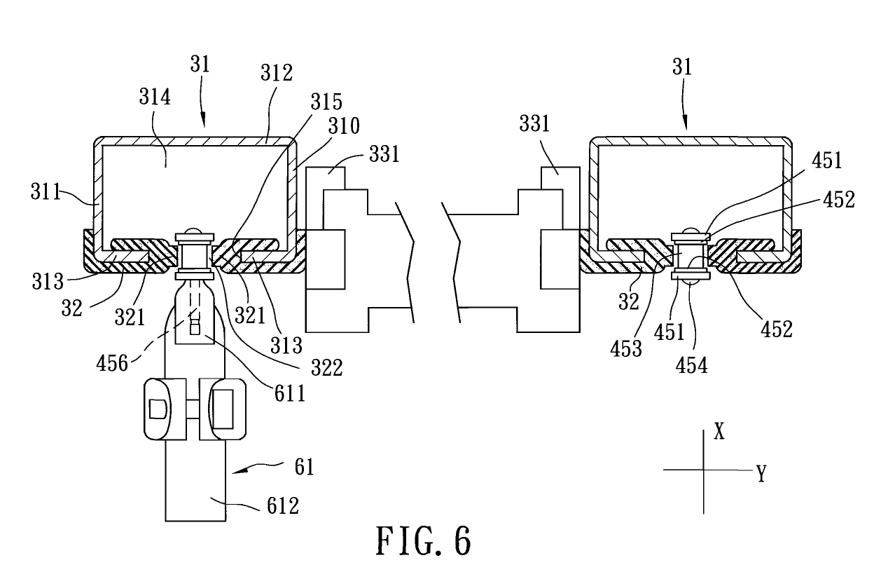

Each of the chain-driven mechanisms 4 includes upper and lower sprockets 41,42 and an endless chain 45. The lower sprocket 42 is mounted on a lower mount 46 which is spaced apart from the upper mount 43 of the respective chain-tension adjusting unit 4 in the upright direction (Z) and which includes a mount plate 461 and two positioning plates 462 secured between the angle bars 310 of the rails 31 of the respective guide rail unit 3, and is revolvable about a sprocket axis in the longitudinal direction (X). The upper sprocket 41 is mounted on two upper plates 432 of the upper mount 43 and is revolvable about a sprocket axis in the longitudinal direction (X). The endless chain 45 is trained on the upper and lower sprockets 41,42, and includes a plurality of parallel pairs of outer link plates 451 which confront the longitudinal direction (X) and which cooperatively serve as a link plate-side looped wall, a plurality of parallel pairs of inner link plates 452 disposed inwardly of the outer link plates 451, a plurality of rollers 453 which are disposed between the inner link plates 452 and which confront the transverse direction (Y) to cooperatively serve as a sprocket-engageable body, and a plurality of pins 454 extending through the outer and inner link plates 451,452 and the rollers 453. Some of the pins 454 further extend from the respective outer link plates 451 in the longitudinal direction (X) to form a plurality of mounting stems 456, as shown in the left part of FIG. 6. Thus, the endless chain 45 includes front and rear straight segments 455 which are disposed in the front and rear guideways 322, respectively, so as to guide the sprocket-engageable bodies 453 thereof to move along the front and rear running routes, respectively.

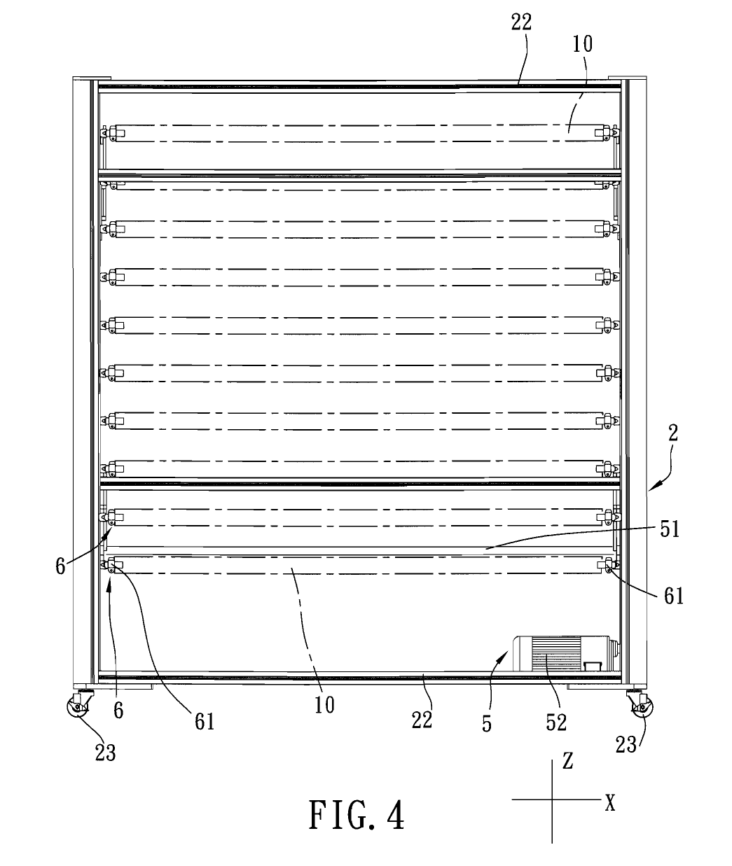

As shown in FIGS. 4 to 6, the drive unit 5 includes a drive transmitting shaft 51 which is disposed to connect the lower sprockets 42 and which is rotated with the lower sprockets 42 about the common sprocket axis, and a drive motor 52 which is disposed to drive one of the lower sprockets 42.

Each of the supporting units 6 includes a pair of fixtures 61, each of which has a coupling portion 611 securely connected to the respective mounting stem 456, and a coupling portion 612 extending in the longitudinal direction (X) and adapted to be coupled with a merchandise roll 10 so as to hold the merchandise roll 10 in the longitudinal direction (X).

In use, by operating the drive unit 5, the lower sprockets 42 are rotated synchronously so as to synchronously move the endless chains 45 as well as the upper sprockets 41, thereby elevating and lowering the merchandise rolls 10 held in the supporting units 6 for facilitating displaying of the merchandise rolls 10. Cutting of a desired measure of the merchandise from a selected one of the merchandise tolls 10 is also facilitated. In addition, by means of the chains 45 which have the sprocket-engageable bodies 453 guided by the guideways 322, and by means of the muffle pads 32, the chains 45 can travel steadily and smoothly without vibration and noise.

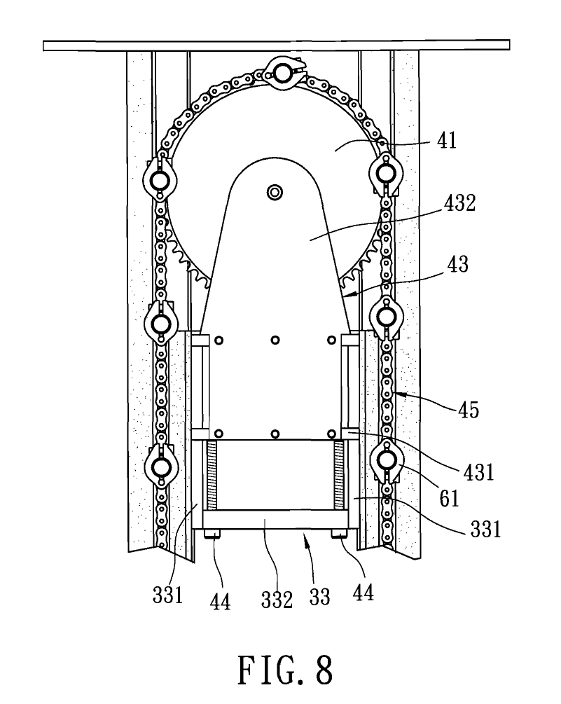

Referring to FIGS. 4, 5 and 8, when the endless chains 45 become loose after long-term use, i.e., clearances between among the link plates 451, 452 are enlarged so that the endless chains 45 are loosely engaged with the respective upper and lower sprockets 41,42 and are in a slack position, the operator can rotate the tightening bolts 44. The threaded movement of the tightening bolts 44 results in upward movement of the actuating ends 441, which causes the upper mount 43 and the upper sprockets 41 to move in the upright direction (Z) relative to the corresponding lower sprockets 42 to a tensed position, where the endless chains 45 can be properly tensed and can be meshed with the corresponding upper and lower sprockets 41,42.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A vertical chain-driven conveyor apparatus for elevating and lowering a plurality of merchandise rolls that extend in a longitudinal direction, said apparatus comprising:
a pair of side frames spaced apart from each other in the longitudinal direction, and each having top and bottom ends opposite to each other in an upright direction that is transverse to the longitudinal direction;
two sets of upper and lower sprockets, said upper and lower sprockets of each set being mounted on a respective one of said side frames, being revolvable about sprocket axes in the longitudinal direction, and being spaced apart from each other in the upright direction;
a pair of endless chains, each trained on a corresponding set of said upper and lower sprockets, and each including front and rear straight segments which are movable respectively along front and rear running routes that extend in the upright direction and between the corresponding set of said upper and lower sprockets, and that are spaced apart from each other in a transverse direction relative to the upright and longitudinal directions, each of said front and rear straight segments having a link plate-side looped wall which confronts the longitudinal direction, and a sprocket-engageable body which confronts the transverse direction;
a pair of guide rail units which are respectively mounted on said side frames, and which extend in the upright direction, each of said guide rail units defining front and rear guideways which respectively guide said sprocket-engageable bodies of said front and rear straight segments to move along said front and rear running routes, respectively; and
a pair of chain-tension adjusting units, each coupled with a respective one of said upper sprockets, and each movable relative to a respective one of said side frames in the upright direction between a tensed position, where a respective one of said endless chains is meshed with a corresponding set of said upper and lower sprockets, and a slack position, where the respective one of said endless chains is loosely engaged with the corresponding set of said upper and lower sprockets.

2. The vertical chain-driven conveyor apparatus according to claim 1, further comprising a pair of guiding rack units, each including a pair of guide bars which are secured to a respective one of said side frames and between said front and rear straight segments of a respective one of said endless chains, which are disposed parallel to each other, and which are spaced apart from each other in the transverse direction, and a crosspiece disposed between said guide bars, each of said chain-tension adjusting units including an upper mount which is disposed for mounting of said upper sprocket revolvably thereon, and which is mounted on and movable relative to a respective one of said guiding rack units in the upright direction, and a tightening bolt which is threadedly engaged with said crosspiece so as to be manually operable to move said upper mount in the upright direction relative to said lower sprocket.

3. The vertical chain-driven conveyor apparatus according to claim 2, wherein said upper mount of each of said chain-tension adjusting units has two guided portions which are engaged with and which are guided by said guide bars of a respective one of said guiding rack units to move in the upright direction, and an abutted portion which is interposed between said guided portions and which confronts said crosspiece of the respective one of said guiding rack units in the upright direction, said tightening bolt of each of said chain-tension adjusting units having an actuating end which extends upwardly of said crosspiece of the respective one of said guiding rack units so as to abut against said abutted portion such that threaded movement of said tightening bolt results in an upward movement of said actuating end to thereby force said upper sprocket of a corresponding set to tense the respective one of said endless chains.

4. The vertical chain-driven conveyor apparatus according to claim 3, wherein each of said guide rail units includes front and rear rails, each having two angle bars which are spaced apart from each other in the transverse direction, and two bent segments which extend toward each other and which are spaced apart from each other by an accommodating gap that extends in the upright direction for insertion of said sprocket-engageable body thereinto.

5. The vertical chain-driven conveyor apparatus according to claim 4, wherein each of said guide rail units further includes front and rear pads, each having two pad portions which extend in the upright direction to upholster said bent segments, respectively, which are configured to cooperatively define a respective one of said front and rear guideways, and which are made from a material that muffles noisy sound when said sprocket-engageable body of a respective one of said front and rear straight segments is guided along the respective one of said front and rear guideways.

6. The vertical chain-driven conveyor apparatus according to claim 4, wherein each of said endless chains has a plurality of mounting stems which extend from said link plate-side looped wall in the longitudinal direction, said apparatus further comprising a plurality of fixtures which extend in the longitudinal direction and which are adapted to couple the merchandise rolls with said mounting stems respectively so as to elevate and lower the merchandise rolls.

7. The vertical chain-driven conveyor apparatus according to claim 1, further comprising a plurality of crossbars interconnecting said side frames, and a plurality of casters disposed on said bottom ends of said side frames for easy movement of said apparatus.

8. The vertical chain-driven conveyor apparatus according to claim 1, further comprising a drive transmitting shaft which is disposed to connect said lower sprockets and which is rotated with said lower sprockets about the common sprocket axis, and a drive motor which is disposed to drive one of said lower sprockets.
